(19) United States
(12) Patent Application Publication
(10) Pub. No.: US 2012/0217667 A1
(43) Pub. Date: Aug. 30, 2012

(54) METHOD FOR RECYCLING PAPER MACHINE CLOTHING

(76) Inventors: Torsten Kallweit, Ulm (DE); Michael Straub, Steinheim (DE); Matthais Schmitt, Munchen (DE)

(21) Appl. No.: 13/410,680

(22) Filed: Mar. 2, 2012

Related U.S. Application Data
(63) Continuation of application No. PCT/EP2010/062665, filed on Aug. 31, 2010.

(30) Foreign Application Priority Data
Sep. 3, 2009 (DE) 10 2009 029 190.3

(51) Int. Cl. D01F 13/00; B02C 18/00; B02C 23/08

(52) U.S. Cl. 264/37.28; 241/24.29

(57) ABSTRACT

A method for recycling the construction material of paper machine clothing, in particular forming screens and press felts to be used as starting product, includes the steps of a) Classification of a starting product to be recycled at least in regard to the material composition thereof, b) Comminution of the starting product and c) Extrusion of the comminuted starting product.

### CROSS REFERENCE TO RELATED APPLICATIONS

This is a continuation of PCT application No. PCT/EP2010/062665, entitled “METHOD FOR RECYCLING PAPER MACHINE LININGS”, filed Aug. 31, 2010, which is incorporated herein by reference.

### BACKGROUND OF THE INVENTION

1. Field of the Invention

The current invention relates to a method for the recycling of paper machine clothing, in particular forming screens, dryer fabrics or press felts, press belts or respectively process belts, for use in starting product.

2. Description of the Related Art

In order to not have to dispose of as waste, clothing used in paper machines, for example in the form of forming screens, dryer fabrics or press felts or respectively process belts when they can no longer be used in paper manufacturing due to having reached a predetermined operational life span or level of wear, clothing of this type was previously utilized as so-called geo-textiles by taking advantage of the open-pored structure, for example in application on levees in order to improve cohesion of the ground or respectively to prevent erosion of earth. Even though this is an absolutely meaningful and desirable form of use of clothing of this type, the fact remains that clothing of this type is constructed of very high-quality material, which is generally not taken into account. On the contrary, use of worn clothing in such applications creates the necessity to manufacture new clothing from virgin material, leading to accordingly high costs. The waste necessarily occurring in the production process of paper machine clothing cannot be directed toward use of this type and must therefore be disposed of as waste, for example by dumping in landfills or burning for energy generation, for example in cement production.

What is needed in the art is a method for the recycling of paper machine clothing which makes it possible to recycle base materials contained in such clothing and to thereby return them into the production cycle in particular for the production of paper machine clothing.

### SUMMARY OF THE INVENTION

The present invention provides a method to recycle the construction material of paper machine clothing, in particular forming screens, press felts, press belts, dryer fabrics and process belts to be used as starting product, including the following steps:
a) Classification of starting product to be recycled at least in regard to the material composition thereof;
b) Comminution of the starting product; and
c) Extrusion of the comminuted starting product.

Since paper machine clothing can be constructed in varying ways from varying materials, the clothing is analyzed according to the present invention in a classification procedure whereby it is determined from which base material or respectively base materials and in what kind of manufacturing method they are constructed in order to be able to determine the subsequent processing measures. The clothing used as starting product and so classified, is then subjected to a comminution process in order to provide, on the one hand suitable, for example homogenous, starting product for the concluding extrusion procedure, which is for example a pelletization procedure, and on the other hand, with starting product containing several base materials to provide the possibility of physical separation and to be able to feed the separated particles of different base materials to the extrusion process, for example within the scope of a pelletization process.

Especially when paper machine clothing of this type is returned from the production process it is sometimes contaminated or full of residue from the paper production process, which could inhibit classification or make it considerably more difficult. Therefore, the starting product prior to conducting step a) and/or after conducting step a) and prior to conducting step b) and/or after conducting step b) may be cleaned in a cleaning process. For this purpose the cleaning process may include pre-cleaning, for example with a scraper or brush, by deformation, vibratory excitation and/or ultrasound, and/or the cleaning process may include a main cleaning process, such as use of a dry ice application and/or washing, for example high pressure washing utilizing tenside and/or solvents, such as terpene.

In order be able to suitably select the processing steps in the inventive method which are to be conducted following classification, when carrying out step a), the starting product is classified as being homogeneous if it is composed essentially of one base material or if the base material includes a mixture of materials, or is classified as mixed if it is composed of at least two different base materials. Step b) may then be conducted dependent upon the result of the classification which was achieved when conducting step a).

Even if prior to step a), in other words prior to classification of the starting product to be recycled, a cleaning process is conducted there is basically a danger that contaminations embedded in the interior of a clothing of this type cannot be completely removed. Therefore, after conducting step b) the comminuted starting product may be cleaned in a further cleaning process. After comminution of the starting product this is broken down into small particles, possibly of various base materials, and the contaminants which are still embedded in the interior volume region of the starting product are generally also present in the form of particles or respectively moisten the surface of the particles which were generated by comminution and can therefore be removed comparably easily in a further cleaning process. Provision may be made that the further cleaning process includes a main wash, such as in a washing machine and utilizing tenside, balls, heat and/or ultrasound. In order to remove the loosened contaminants after the further cleaning process, after the main wash, a rinse and/or spin process may be implemented.

Depending on the composition of the base material or base materials of the starting product to be recycled, the starting product can have a comparatively high liquid content in its interior volume region, originating from the permanent contact with water in the paper manufacturing process. In order to ensure that the comminuted starting product that is to be fed to the pelletization process can be converted to high-grade granulate, prior to conducting step c), the comminuted starting product may be pre-dried.

It has moreover been shown that during pelletization—depending on the base material which is provided to the pelletizer, the polymer chain structure can be partially destroyed, so that a clear viscosity reduction occurs. In order to counteract this, after conducting step c) a poly condensation is implemented.

Pre-drying of the comminuted starting product and/or the poly condensation is implemented for example if the pellets obtained through implementation of step c) are composed of polyamide or polyethylene terephthalate.

In order to break down the starting product into particles of the desired size during implementation of step b), if necessary also depending on the result of the classification obtained during implementation of step a), it may be provided that step b) is implemented with a cutting mill, a multiple comminutor, a cutter, a hand-cutter, a shredder, a guillotine or a splitting machine.

In order to be able to achieve a homogeneous granulate when conducting step c) which can then be fed to the new manufacturing process, after implementation of step b) and before implementation of step c), the comminuted starting product is separated into components of different base materials.

It has been shown that separation of the comminuted starting product into components of different base materials can be achieved at very high efficiency by density separation supported centrifuging, air separation or partial agglomeration supported screening.

Measure a), in other words classification of the starting product, may occur for example through near infrared spectroscopy. The starting product is hereby optically examined. The frequency or respectively wavelength components contained in the result of this spectral examination are characteristic for the starting product or respectively its construction material and allow for the same to be identified in regard to its components—in other words in regard to the base materials contained in the starting product.

The current invention further relates to a method for recycling of construction material of paper machine clothing, in particular forming screens and press felts as a starting product, including comminuting the starting product using a cutting mill and/or separation of particles of different base materials contained in the comminuted starting product using a density separation support centrifuging process.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a flow chart depiction of the basic sequence of a method for recycling of paper machine clothing according to the present invention;

FIG. 2 is a flow chart depiction of the process sequence during recycling of used paper machine clothing in the embodiment of a fabric according to the present invention;

FIG. 3 is an alternative process sequence during recycling of used paper machine clothing in the embodiment of a fabric according to the present invention;

FIG. 4 is a flow chart depiction of the process sequence during recycling of a used paper machine clothing in the embodiment of a press felt according to the present invention; and

FIG. 5 is a depiction of a process sequence alternative to the process sequence in FIG. 4 during recycling of a used press felt.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

During recycling according to the present invention of paper machine clothing one can basically differentiate between two different groups of starting product to be recycled. A first of these groups includes all paper machine clothing which was previously used. In other words that which during the production of paper in paper machines was in contact with the paper that was to be produced or respectively with the base material for same. This paper machine clothing is generally comparatively strongly contaminated even if it was continuously cleaned during the paper manufacturing process. The second group includes all paper machine clothing or respectively parts or sections thereof which develop during the production of the paper machine clothing as scrap or waste. Since this clothing used as starting product was not previously used in the paper manufacturing process is therefore to be considered as “brand new” it is generally not loaded with contamination.

The two groups of starting product differ essentially in that the first mentioned group is loaded comparatively heavily with contaminants and is therefore advantageously subjected to a cleaning process before further processing, whereas this is not necessarily the case with the second group. With the differentiation whether the starting product to be processed is fed as return from the paper manufacturing process or as return from the paper machine clothing manufacturing process, a first step of classification already occurs whereby for example a differentiation is made in regard as to the path of delivery over which the starting product to be recycled is fed. This classification may occur mechanically, possibly also by identifying the delivery path but can of course also be made manually. The classification or respectively the differentiation between a starting product which was previously used in the paper manufacturing process and a starting product from the paper machine clothing production process can also occur under consideration of the geometric structure of the starting product. So it may for example be assumed when edge trims or smaller pieces of starting product are supplied that these were rejects from the production process of the paper machine clothing and that, under consideration of the fact that they are generally not contaminated, they can be further processed without a cleaning process. In the manufacture of paper machine clothing presorting or respectively classification can already be undertaken in that the waste materials, for example also edge trims or left over yarn are placed in a designated container at the point of origin and are not subsequently, or respectively before recycling, mixed with other waste occurring at a different location. It can also be concluded, for example through identification of the container containing the hereby sorted starting product from which segment of the production process it originated and as to how the product is to be treated during recycling.

If the starting product to be recycled is paper machine clothing from the paper manufacturing process, then for example a mechanical pre-cleaning process prior to a subsequent classification ensures that larger contaminants, such as those accumulated on the surface, are removed. Different mechanical equipment—for example scrapers or brushes—can be utilized in mechanical pre-cleaning. Also, deformation of the starting product can lead to loosening of contaminants, as well as stimulation to vibrations, and ultrasound. Mechanical vibrations, for example those of a tumble screen can also lead to loosening of contaminations. This effect can be intensified with the assistance of freely moving brushes on the topside of the tumbler screen.

During screening, for example when using a tumbler screen, pintle wires accumulate for example from previously comminuted and completely broken up fabrics of spiral screens, mostly at a fraction of about 1.0-1.25 millimeter (mm) (spread over the fraction of about 0.8-1.0 mm and about 1.25-1.5 mm).

Filler wires mostly accumulate in the fractions of approximately 1.5-2.0 mm and approximately 2.0-2.5 m. The spread is clearly greater than with pintle wires and is reflected at approximately 0.8 to >5 mm in the fractions. Spiral yarn particles accumulate barycentric in the fractions of about 0.6-0.8 mm and about 3.15-4.00 mm.

After the pre-cleaning process the contaminants embedded further in depth can be removed in a main cleaning process. A cleaning process utilizing dry ice has proven to be effective in this regard. Here, the starting product to be recycled is blasted with dry ice, in other words with solid carbon dioxide as an abrasive, at a temperature of approximately −79° C. The chemically inert dry ice which does not react with the construction material of the starting product to be recycled transitions at ambient pressure directly from solid to gaseous state and due to embrittlement of the contaminant particles and the spontaneous volume increase occurring during the transition into the gaseous state, the dry ice loosens the contaminant particles. The cleaning effect can on the one hand be intensified through oscillation of the dry ice blast prior to impingement upon the surface to be cleaned, and on the other hand later by bringing together dry ice and a high pressure jet only in the compressed air pistol. Alternatively or in addition, the starting product may be influenced mechanically in a washing operation, for example through high pressure washing whereby tenside can be added to the cleaning fluid in order to allow, through reducing the surface tension, penetration of fluid, for example water, into deeper embedded regions of the starting product to be recycled. Moreover, when using high pressure washing the cleaning effect can also be improved through oscillation of the high pressure water jet.

After this first cleaning process the paper machine clothing returned from the paper manufacturing process is comparatively clean and can, as well as the new paper machine clothing or waste from the production of same allocated to the second referred to group, be furnished to a further classification.

Paper machine clothing, depending on which area of the paper machine it is utilized in, generally assumes different forms. Forming screens used in the first segment of paper manufacturing are generally in the form of fabrics, whereby these fabrics can be homogeneous—in other words all warp yarns and respectively weft yarns used to produce the fabric are composed of the same base material. Or, they can be non-homogeneous or also mixed. Mixed fabrics include for example in their base material differing warp yarns on the one hand and weft yarns on the other hand or also within these yarn categories yarns of different base materials. In fabrics of this type, or respectively yarns used to produce such fabrics, the base material itself can be fundamentally homogeneous, in other words consist of a single material, whereas material mixtures are also possible. This means that a yarn of a fabric composed of a material mixture can basically be considered as homogeneous since the base material to compose such a yarn should again be available at the end of the recycle process in the existing mix ratio of the different materials in order to be able to furnish this mixed base material again to the production process of such yarns.

As long as one component of the starting product—whether yarn or fiber—exists already in a material mixture, such a material mixture can in the sense of the current invention be regarded as a base material to be provided again at the end and can therefore be considered as homogeneous.

Press felts used in wet sections are generally designed with a carrier structure absorbing the mechanical load in a machine direction and a cross machine direction, which for example include a woven fabric, a laid scrim or spiral elements connected by pintle wires. One or several porous layers of for example nonwoven material can be applied onto a carrier structure of this type and can be connected with same for example through needling. This means that such press felts are essentially a composite structure which in itself can again be composed of several components, for example with warp and weft yarns in the region of the carrier structure. This generally results in that such press felts are not considered a homogeneous starting product, even though this could basically also be the case.

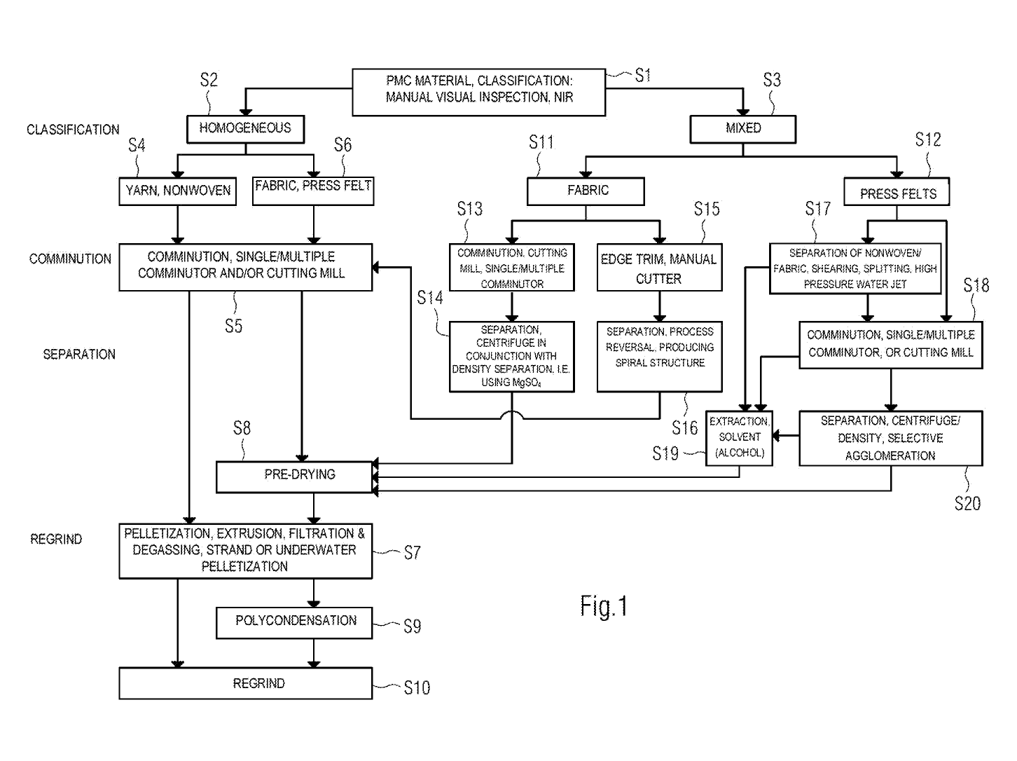

In a classification process which is to be conducted after completion of the aforementioned cleaning procedure (S1 in FIG. 1) differentiation is made as to in which form the starting product to be recycled is available. At least in a supporting role this can also occur through visual inspection, in particular if a differentiation is to be made between fabrics and forming screens on the one hand and composite structures such as press felts on the other hand. In such visual checks a more extensive analysis as to whether different base material is used for example for warp and weft yarns or for the nonwoven and the carrier structure, is often difficult.

In order to be able to conduct a more precise analysis or classification, optical inspection methods can be employed, for example near infrared spectroscopy. The starting product to be recycled which is to be analyzed or classified is hereby radiated with shortwave infrared light. The resulting analysis spectrum is characteristic for the used base material and allows identification of various materials contained in the starting product, for example poly materials. It can thereby be determined whether the starting product which is to be recycled is homogeneous or mixed, and if it is mixed which base materials are contained in the mixture.

The classification can continue to be conducted under consideration of information which is available in regard to the starting product to be recycled. This information can for example be provided by data associated with the production process of paper machine clothing, for example data regarding the construction material. All paper machine clothing inserted into the paper manufacturing process is basically identified or identifiable so that in allocating such clothing available information for example through read-out from a data bank can be used in the classification. An optical inspection can for example be avoided if such accompanying information is available, thereby accelerating the recycling process.

Following the classification it is therefore clear whether the starting product to be recycled is homogeneous and represents a material mixture or whether the homogeneous starting product S2 is present in the embodiment of yarn, nonwoven, woven fabric or press felt. Even with the starting product provided from the mixture S3 it is distinguishable whether this is present as fabric or press felt.

After this classification process the starting product is comminuted in the next step. It must be pointed out that for example already before the classification and/or in a cleaning process which is to be conducted prior to it a pre-comminution can occur in the sense that generally very large paper machine clothing is cut into smaller pieces in order to be able to handle them easier. This pre-comminution can occur by using cutting tools, for example cutting machines, or also manually.

If the homogeneous starting product is present in the form of yarn or nonwoven material S4, which will be the case in general if these are waste supplies left over from the manufacturing process of paper machine clothing, then the yarn material can be separated from a reel onto which it is wound by using a guillotine or similar device. A further comminution can then occur by using suitable mechanical methods. For example a single wave comminutor, a multi comminutor, a shredder, a guillotine or a cutting mill can be used. A critical success factor for comminution is hereby that the employed method or the utilized comminutors employ cutting or chopping as comminution principle.

So-called cutting mills have proven to be very effective in recycling of paper machine clothing, whereby a plurality of knives is provided on a rotor which interact in a rotational motion with knives mounted on a stator, thereby cutting in a shearing process the bodies existing in this region which are to be comminuted. A screen capturing the comminuted bodies ensures that only particles of a certain maximum size defined by the screen are discharged from a cutting mill of this type, whereas remaining larger particles are directed to the further comminution process.

Even if the starting material is a fabric or a press felt which is constructed of a carrier structure and nonwoven material of the same base material S6 a further comminution can occur using a cutting mill, so that particle material having a particle size of less than approximately 4 mm, such as less than approximately 2 mm is produced.

The particle material resulting from this comminution S5 is then processed further, depending on which material this particle material which is basically considered to be homogeneous, is composed of. If for example the base material is PPS (polyphenylene sulfide) then this particle material can be fed directly to pelletization S7 which is then to be conducted. If this material is PA (polyamide) or PET (polyethylene terephthalate) then it is first subjected to pre-drying S8. This is necessary since this type of material, especially if it is produced from paper machine clothing previously used in the paper manufacturing process, can have a comparatively high water content of up to 8% in its volume region near the surface due to its extended contact with water. This water content can be clearly reduced in the pre-drying process, for example through heat, so that the material which is then to be fed to pelletization can be considered as dry.

During pelletization S7, the comminuted, possibly pre-dried particle material is treated in a manner known for example from recycling PET bottles. In pelletization of this type the particle material is for example fed to a single screw type extruder where the particle material which is moved by the screw is melted in order to cleanse it from transient contaminants in a degassing step. The melt can then be filtered with or without backwashing and can be further processed into pellets in a water ring pelletizing process, an underwater pelletizing process or a strand pelletizing process.

In basic aspects the previously described pelletizing process is consistent with an extrusion process in which for example the yarns which are to be utilized in a weaving process can be produced. In such an extrusion process the particles obtained in the previously discussed recycling procedure can be converted directly—in other words without the intermediate step of producing pellets, by conducting an extrusion step, possibly with simultaneous degassing, a filtration step and then by guiding the so processed material through spinnerets or similar devices—to yarns or other starting products, for example for the production of paper machine clothing. This means therefore that a complete pelletization does not necessarily have to be conducted, in other words that the intermediate step in the production of granulate again to be fed to a pelletizing process can be eliminated.

If the thereby obtained pellets consist of PPS they can be utilized immediately in the restoration of for example yarn or fiber material. If the pellets consist of PA or PET it may be necessary to first ensure in a polycondensation process that the viscosity which was reduced due to break-up of the chain structure in the implementation of pelletization is again raised S9. After this polycondensation the pellets resulting from it can also be returned again to the manufacturing process S10.

If the classification has shown that the starting product to be recycled is mixed S3 then, as illustrated in FIG. 1, a fundamentally different procedure is followed, depending on whether this mixture is a fabric S11 or a press felt S12. In the case of a fabric it can first be determined whether it is a conventional fabric with warp and weft yarns, or a structure with a plurality of spirally or helically formed elements extending in the cross machine direction of a paper machine clothing and which are connected with each other through pintle wires which are inserted through an overlapping region. Additional filler yarns can be inserted in such non-woven structures which reduce the hollow space volume share.

If it is a classic woven fabric then this can be comminuted in, for example a single or multiple comminutor, a cutting mill or a combination thereof, in order to obtain particle material in the previously described manner S13. If particular attention is paid hereby to the particle size being less than approximately 4 mm, for example less than approximately 2 mm it is ensured that all fabric structures created from cross-over of warp and weft yarns are broken up, so that no linked particles of different materials are present. Based on the fact that the fabric was mixed, the hereby obtained particle material contains particles of different base materials. These must subsequently be separated from each other in order to ensure that homogeneous particle material is available for pelletization S14. With dryer fabrics, for example spiral screens, comminution of the materials to a monofilament particle length of approximately 6 to 8 mm is sufficient for complete breakdown of the structure.

This separation of particles of different base material can occur in different ways. This can occur for example through air separation or screens, such as by use of tumble screens, possibly in connection with brushes moving freely on the top surface of the screen, supported by a partial agglomeration generated by heating above a melting point, in order to be able to screen or respectively filter out the thereby partially agglomerated particles and to therefore be able to separate particles of different base materials from each other.

This separation may be implemented by use of a centrifuge and a density separation. In a centrifuge of this type, or respectively in a device known as a decanter the particles of different base materials carried along in a fluid are brought into a cyclic flow. A density separation occurs hereby due to the generated centrifugal force, whereby particles with a base material having a greater density will accumulate in the radially outer flow region. This particle separation occurring in a centrifuge or respectively in a decanter, facilitated by the centrifugal force can be further supported in that the liquid containing the particles of different base material is provided in a consistency which enables an additional separation supported by density variation. If for example particles of PA and particles of PET are contained in the particle material resulting from the comminution, then the particles in the case of the PA particles have a density in the range of 1.13 grams per cubic centimeter (g/cm³) to 1.24 g/cm³. The PET particles have a density in the range of 1.38 g/cm³. The density separation medium used is then for example magnesium sulfate (MgSO₄) which has a density of approximately 1.25 g/cm³. Potassium carbonate (K₂CO₃) also has a density of approximately 1.25 g/cm³ and could also be used. One can see that the density of the separation medium is between the densities of the base materials of the particles of the particle material, so that this density differential will result in that also based on gravity or facilitated by centrifugal force the particles having higher density on the one hand, and the particles having lower density on the other hand will be separated from each other and that the separation medium having the medium density will accumulate between these phases. The hereby separated particles can then be removed in a continuous process and can be directed to further processing in two separate material flows. Here it is to be considered that these material flows not only contain the particles which were separated on the basis of their base material, but also at least portions of the separation medium, for example magnesium sulfate. This material which essentially moistens the surface of the particles can then be removed in a cleaning process with water, possibly with the water contained in the particle material. Subsequently pelletization S7 can again occur, if required with downstream polycondensation S9.

In regard to the two hereby obtained material flows one can generally assume that the material flow containing the fraction having the higher density, in other words containing the PET particles is comparatively clean and that it can be directed to additional processing after the removal of the separation medium still contained therein, for example in a cleaning process with water. The material flow containing the fraction having the lower density, in other words containing the PA particles may however also still contain contaminating particles which, for example, get into the process due to packaging material surrounding or holding together the starting product which was not completely removed. Contaminants of this type consist normally of polyolefin which has a density of less than 1 g/cm³. This material flow containing the fraction having the lower density can then again be subjected to the previously described separation process, whereby however water is now used as separation medium. In this renewed separation, two material flows are again generated, whereby the fraction having the higher density essentially only contains the PA particles now, whereas the fraction having the lower density contains the contaminants and can be removed from the further conversion process.

If the fabric is in the embodiment of the aforementioned spiral or helical structure then the comminution process can occur in that initially edge trims are cut from the starting product by means of a cutting device S15. In these edge trim pieces which can have a width of approximately 1 cm to 2 cm, the spiral or helix wound elements are firmly connected with pintle wires or filler yarns in order to avoid their lateral detachment from the paper machine clothing. This connection occurs generally through gluing or melting and is practically not soluble. This means that the hereby cut trims are generally to be regarded as scrap since they contain a mixture of various base materials which cannot be separated, at least not mechanically.

After severing the edge trims the filler yarns contained, for example, in the helical structure can be removed comparatively easily, since they are contained substantially loosely in the hollow spaces. Even lateral tipping of the starting product or larger pieces thereof can result in that the filler yarns slip out in a downward direction and are thereby separated from the helically or spirally wound elements. In principle this is a reversal of the manufacturing process of such spirally or helically wound structures S16. The components separated from each other can then be fed as essentially homogeneous products to the previously already discussed comminution and subsequent, possibly material based further conversion. Here it must be considered that the pintle wires which are difficult to extract from the helical structure are generally constructed from the same polymer material as the helically wound elements and that to that extent also a homogenous product exists on which separation of the particles is not necessary after comminution. Should this not be the case, then a mixture of particles of various base materials exists after comminution, which can be separated into the different components in the previously described manner, and can then be further processed.

If the classification has shown that the starting product which is to be processed is a press felt S12 with mixed base materials for a fabric representing the carrier structure on the one hand, and the nonwoven material connected with it for example through needling on the other hand then, as indicated on the right side of FIG. 1, various procedures can be followed. In one possible variation the nonwoven material or a large part thereof can first be removed from the fabric, for example by using a shearing or splitting tool S17. Since, during this shearing process at least a small part of the fibrous material of the nonwoven remains in the fabric structure, the remaining fibrous material can be removed from the surface of the fabric by additionally blasting the surface of the fabric with a high pressure water jet. In this procedure the fabric, essentially no longer containing nonwoven material remains. The non-woven material detached through the shearing process, as well as the nonwoven material removed by the high pressure water jet which generally will have an already very small particle size will not necessarily have to be reduced further. The fabric and the nonwoven material can then be fed to comminution process S18 which occurs, for example, separately if the fabric on the one hand and the nonwoven on the other hand are constructed of different base materials, so that a subsequent separation of the particles can be avoided. In one variation the entire nonwoven can be detached from the carrier structure by means of a high pressure water jet and hereby possibly also comminuted.

If the nonwoven was homogeneous, in other words constructed from only one base material it can, like the nonwoven particles removed by the high pressure water jet be subjected after comminution to a cleaning process in one extraction step S19 by use of a solvent, for example an alcohol solution. The copolymer fibers, for example polyamide fibers used in the construction of nonwoven material are generally moistened on their surface with an additional copolymer. This copolymer which further facilitates conglutination of the nonwoven fibers is detached in this extraction process and removed with the solution. The then cleaned particles of the nonwoven base material are fed to pelletization S7 possibly with interposition of pre-drying step S8 if this is necessitated by the base material.

If the nonwoven or the fabric is not homogeneous then the comminution results in a particle mixture containing particles of different base materials. These are subsequently separated from each other S20, for example in the manner previously described by utilizing a centrifuge with density separation, or by selective agglomeration, in other words, forming larger material particles by increasing the temperature of a liquid containing the particles to above the melting temperature of the base material having the lowest melting point. The particles thus separated from each other can then be cleaned in an extraction step with an alcohol solution of surface moistening substances S19, for example in the case of the nonwoven particles. The separated particles of the fabric can in that case be fed directly to pelletization S7 whereby here too, depending on the material pre-drying step S8 can be interposed.

It is self-evident that in the case where the nonwoven and/or the fabric were basically homogeneous a separation is not necessary, if the nonwoven or fabric were comminuted separately.

In an alternative procedure the press felts can be comminuted S18 as indicated by classification S12. This means the nonwoven and the carrier structure, for example a fabric are comminuted together. The thereby obtained mixture of particles of different construction material is separated for example in the previously described manner S20, following which those particles which are created through comminution of the fabric or carrier structure component of the press felt, are immediately fed to the pelletization or pre-drying, whereas the particles resulting from comminution of the nonwoven component are directed to extraction S19, that is surface cleaning by means of an alcoholic solution, and are only then passed along.

Previously a method was fundamentally described with reference to FIG. 1 with which different paper machine clothing or parts thereof which are returned either from the paper manufacturing process or from their production process are further converted depending on how they are constructed, so that at the end of the process depending on whether homogenous or mixed base material of the starting product is available, one or several types of pellets can be obtained. These can then again be returned into the production cycle of the materials required for construction of paper machine clothing, in particular yarns or fibers. This process is explained again below with reference to several specific examples of a paper machine clothing.

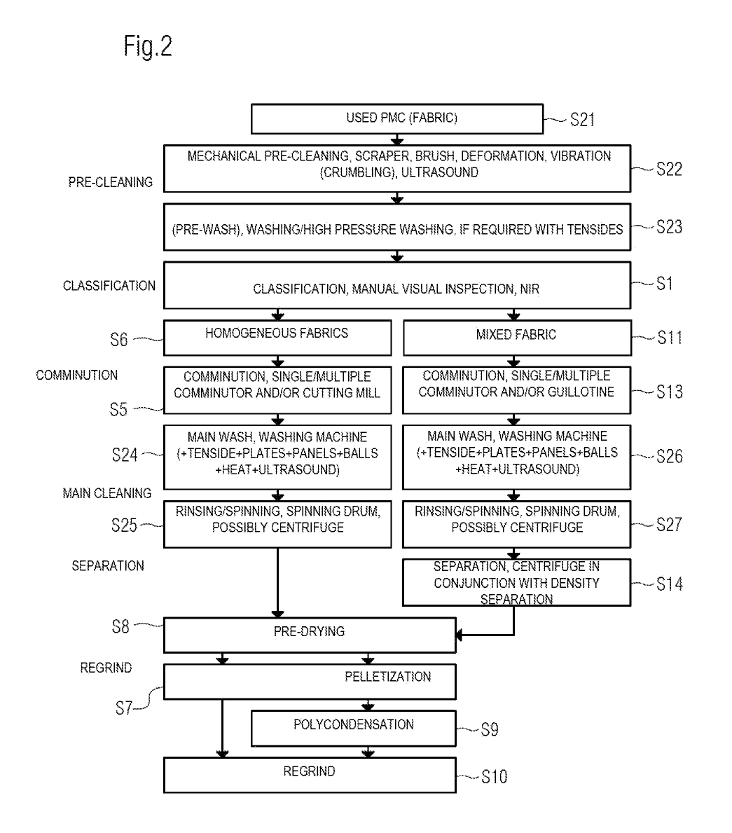

Referring now to FIG. 2, there is shown an example in which a used paper machine clothing (PMC)—in other words one which was used in the manufacture of paper—in the embodiment of a fabric is to be recycled S21. A paper machine clothing of this type was utilized for example in the embodiment of a forming screen and is therefore relatively heavily contaminated. Before further classification S1 takes place this paper machine clothing after having been separated into larger pieces is, if necessary cleaned in mechanical pre-cleaning S22 by action upon the surface whereby contaminants adhering to same are removed. A subsequent step, for example with a high pressure washer, if necessary with the use of tensides attempts to loosen contaminants which are located in the interior of the fabric S23. The thus cleaned starting product which is possibly sectioned into pieces is then classified as to whether it is homogeneous or mixed S1, S6, S11. If appropriate this can occur through visual inspection, however, a more precise analysis can occur by using optical methods, such as the near infrared spectroscopy.

If this classification shows that a homogeneous fabric exists S6 then this is comminuted for example in a cutting mill S5. The thus obtained homogeneous particle material consisting of one base material is then subjected in a next cleaning procedure, initially to main wash S24. For this purpose a washing machine may be used in which the particles are cleaned in water, for example by using tensides, and balls, plates and/or panels effecting further mechanical cleaning at increased temperature and possibly also with the effect of ultrasound. During this cleaning process softeners still adhering to the surface of the particles, in other words spinning oils which are generally applied to fabrics for easier conversion and which are basically water soluble are also removed. The thus cleaned particles are then rinsed and spun in order to separate them from the washed-out contaminants S25. In a step for pre-drying S8 upstream from pelletization S7 the water still adhering to the surface after rinsing and spinning is removed. Moreover, for example, if the base material is PA or PET liquid accumulated in its volume region near the surface is removed. Subsequently the particle material is processed in a pelletizing device in the previously described manner in order to have pellets available S10 which can be used in further processing after polycondensation step S9.

If classification 51 shows that a mixed fabric S11 exists, then the particle material is separated S14 for example in a centrifuge with density separation, after comminution S13 for example in a cutting mill and cleaning in main washing process S26 with subsequent rinsing and spinning S27. The separated, but now homogeneous particle materials are, if applicable fed to pelletization S7 following pre-drying S8. Here too, pre-drying S8 can be helpful, regardless of whether the base material permits penetration of liquid in a measurable amount since, the particle material also emerges generally moistened from separation S14. For this purpose, the separation medium may be rinsed out for using density separation with clean water, for example in an additional rinsing process, so that only water is removed during pre-drying S8 and so that there is no danger that any residues remain on the particle surface.

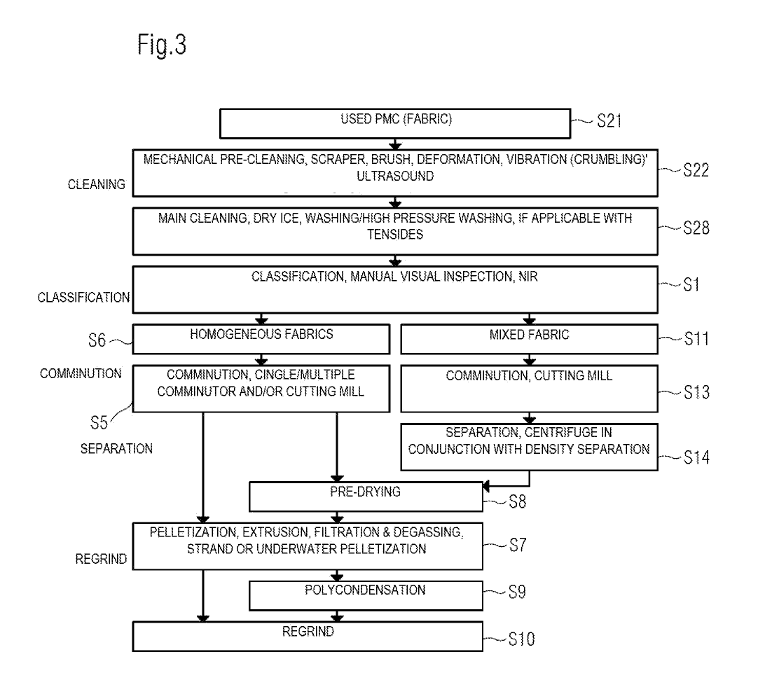

Referring now to FIG. 3, there is shown an alternative procedure in recycling of used paper machine clothing in the form of fabric S21. It can be seen that, before this starting product is classified in detail the fabric is cleaned in main cleaning procedure S28 following mechanical pre-cleaning step S22, either alternatively or possibly additionally to the high pressure wash in order to remove deeper embedded contaminating particles. After classification 51 and depending upon whether homogeneous fabric S6 or mixed fabric S11 exists, comminution S5 and then pelletization S7 in a pelletization unit occurs, or after comminution S13 the particle material is divided in separation step S14 into groups of different base materials and is then fed to pelletization S7. Here too, the discussed cleaning steps can be implemented if applicable before delivery to pelletization S7 or pre-drying S8.

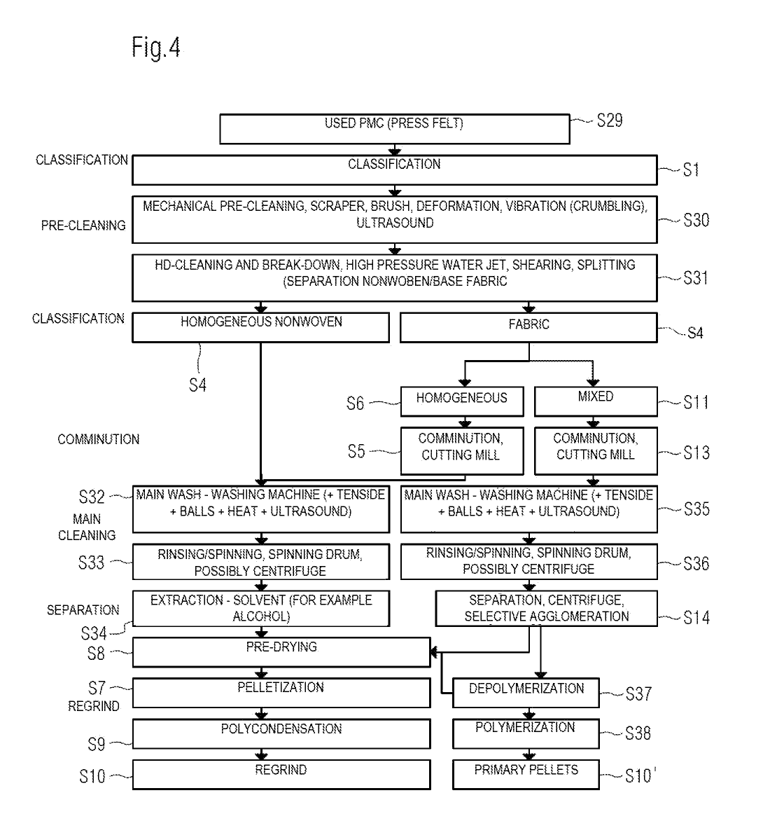

Referring now to FIG. 4, there is shown a procedure in which a used press felt is reused S29. After already having been classified S1 as a press felt, the press felt is subjected to a cleaning procedure. This includes mechanical pre-cleaning S30, followed by high pressure cleaning S31 whereby the nonwoven is separated from the carrier structure, for example from a fabric with a high pressure water jet and, if applicable, using a splitting tool. In this example a homogeneous nonwoven S4 then results which—following main wash S32 and rinse/spin procedure S33 and subsequent cleaning S34 of the copolymer adhesives moistening the nonwoven particles, especially if PA was used as base material—is fed to pelletization S7 and if applicable to polycondensation S9 after pre-drying S8.

If the fabric is homogeneous S6 it will be subjected after comminution S5 to main wash S32 and to rinse/spin procedure S33 similar to the nonwoven particles resulting from the high pressure cleaning procedure, and is then fed to pelletization S7. Removal of the surface-moistening material is here generally not necessary.

If the fabric is not homogeneous S11 it is subjected to separation process S14 after comminution S13 and subsequent washing procedure S35, S36. The particles emerging after separation S14—as long as they are then to be considered homogeneous—are fed to pre-drying S8 and further to pelletization S7. This is possible without any problem for example if the mixed fabric was constructed of PA on the one hand and PP (polypropylene) or PU (polyurethane) on the other hand. If however, different polyamides were used in the construction of the fabric then these can generally not be separated in the separation process which takes advantage of the density differences, since the existing density differences are too small. Therefore the procedure can be such that one of the polyamide components is broken down chemically in depolymerization step S37, so that for example caprolactam is obtained. This can then again be polymerized in subsequent polymerization step S38, in order to obtain—similar as in the production of new material—polymer pellets S10′, such as polyamide pellets, for example PA6-pellets. The polyamide which is not broken up chemically in depolymerization S37 is essentially homogeneous and can be subjected to pre-drying S8 and subsequent pelletization S7.

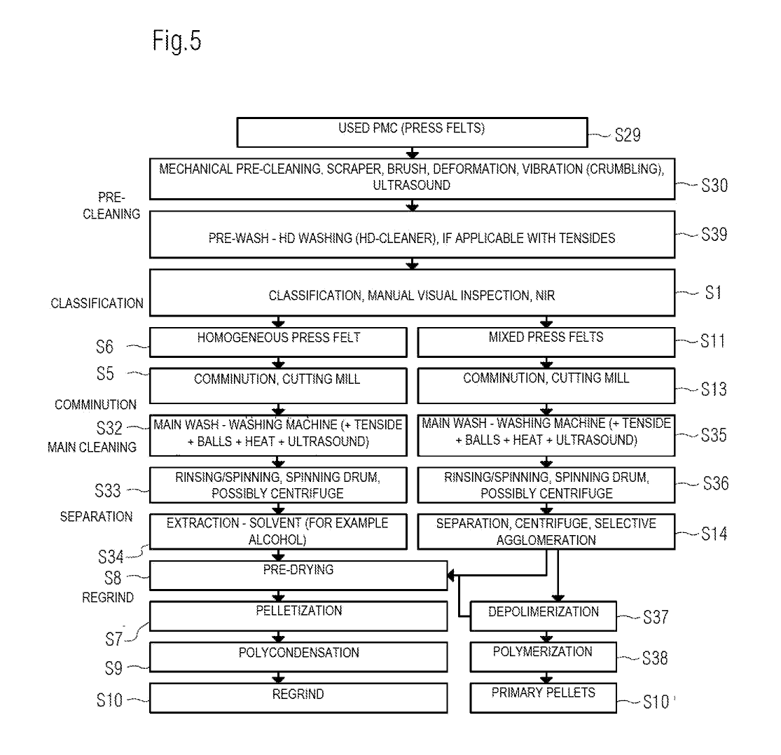

An additional alternative procedure in recycling the construction material of a used press felt is illustrated in FIG. 5. In this example the used press felt S29 after having been cut into larger pieces is, if applicable, also subjected to mechanical pre-cleaning S30 and then to pre-wash S35, for example with the use of a high pressure cleaner. The then available detailed classification S1 provides whether it is a homogeneous or a mixed press felt. The homogeneous press felt S6, in other words a press felt in which the nonwoven as well as the carrier structure, for example a woven fabric are constructed of the same material may for example be comminuted S5 in a cutting mill and then be subjected to previously already explained main wash S32 with subsequent rinsing and spinning S33. Particles resulting from comminution of the woven fabric are cleansed of softeners. The copolymers still moistening the surface of the particles which resulted from the nonwoven comminution are detached in subsequent extraction step S34 and are discharged with the solvent. The thus obtained homogeneous particle material is pre-dried S8 if necessary and then fed to pelletization S7. The thus obtained pellets S10 can then be subjected to polycondensation S9 if necessary in order to obtain the desired viscosity.

If the classification shows that a mixed press felt S11 is to be processed then, according to the procedure illustrated in FIG. 5 the press felt is comminuted S13 in its entirety and after implementation of main wash S35 and respectively rinsing and spinning S36 is subjected to separation S14. If necessary, selective agglomeration can also be used here which can be advantageous if the particle material obtained after comminution contains more than three base materials. If homogeneous particle flows are obtained already during separation, these can then be fed immediately to pre-drying S8 and then to pelletization S7. If the previously described situation is again the case where the different base materials cannot be separated in the separation step based on too small density differences and/or too small melting temperature differences then one of the particle components can again first be broken down in depolymerization S37 and can then be fed to subsequent polymerization S38, whereas the other particle component which is not broken down can be fed to pre-drying S8 and following pelletization S7, essentially as homogeneous particle material.

In conclusion it must be pointed out that the previous description, in particular in reference to FIGS. 2 through 5 are simply examples which are intended to illustrate how paper machine clothing, especially if the starting product to be recycled is initially categorized in a first classification step already as a used press felt or as used fabric, can be further processed under consideration of the then respectively existing firmly defined construction material. These examples can obviously be modified in various aspects, for example in regard to the devices used for comminution or respectively for separation.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of recycling construction material of a paper machine clothing, the method comprising the steps of:
classifying a starting product to be recycled at least in regard to a material composition of said starting product;
comminuting said starting product; and
extruding said comminuted starting product.

2. The method according to claim 1, wherein the paper machine clothing is one of a forming screen, a press felt, a press belt, a dryer fabric and a process belt.

3. The method according to claim 1, further comprising the step of cleaning said starting product in a cleaning process, said cleaning process being at least one of prior to and after said classification step and at least one of prior to and after said comminuting step.

4. The method according to claim 3, wherein said cleaning process includes a pre-cleaning step.

5. The method according to claim 4, wherein said pre-cleaning step includes using at least one of a scraper, a brush, deformation, vibratory excitation and ultrasound.

6. The method according to claim 5, wherein said cleaning process includes a main cleaning process.

7. The method according to claim 6, wherein said main cleaning process includes at least one of application of dry ice and washing.

8. The method according to claim 7, wherein said washing is a high pressure washing.

9. The method according to claim 8, wherein said high pressure washing is with at least one of oscillating dry ice and a high pressure water jet utilizing at least one of tenside and a solvent.

10. The method according to claim 9, wherein said solvent is terpene.

11. The method according to claim 1, wherein said starting product is classified in said classification step as one of homogenous and mixed, said homogenous starting product being one of a single base material and a base material including a mixture of materials and said mixed starting product being at least two different base materials.

12. The method according to claim 11, wherein said comminuting step is conducted dependent upon a result of said classification step.

13. The method according to claim 12, wherein said comminuted starting product is cleaned in an additional cleaning step after said comminuting step.

14. The method according to claim 13, wherein said additional cleaning step includes a main wash.

15. The method according to claim 14, wherein said main wash is in a washing machine and utilizes at least one of tenside, balls, plates, panels, heat and ultrasound.

16. The method according to claim 15, further comprising implementation of at least one of a rinse and a spin process after said main wash.

17. The method according to claim 16, further comprising a further cleaning process, said further cleaning process being conducted dependent upon said result of said classification step.

18. The method according to claim 1, further comprising a pre-drying of said comminuted starting product prior to said extruding step.

19. The method according to claim 18, further comprising implementation of a poly condensation step after said extruding step.

20. The method according to claim 19, wherein if a plurality of pellets obtained through said extruding step are composed of one of a polyamide and a polyethylene terephthalate, at least one of said pre-drying step and said poly condensation step are implemented.

21. The method according to claim 1, wherein said starting product is comminuted using one of a cutting mill, a cutter, a hand-cutter, a shredder, a splitting machine, a guillotine, a single comminutor and a multiple comminutor.

22. The method according to claim 1, further comprising separation of said comminuted starting product into a plurality of components of different base materials after said comminuting step and before said extruding step.

23. The method according to claim 22, wherein said comminuted starting product is separated using one of density separation supported centrifuging, air separation and partial agglomeration supported screening.

24. The method according to claim 1, wherein said starting product is classified using near infrared spectroscopy.

25. The method according to claim 1, wherein said extruding step includes pelletization of said comminuted starting product.

26. A method of recycling construction material of a paper machine clothing to be used as a starting product, the method comprising the step of comminution of said starting product using at least one of a) a cutting mill, and b) a density separation support centrifuging process which separates a plurality of particles of a plurality of base materials contained in said comminuted starting product.

27. The method according to claim 26, wherein said paper machine clothing is one of a forming screen and a press felt.
